(19) United States
(12) Patent Application Publication
(10) Pub. No.: US 2025/0278298 A1
(43) Pub. Date: Sep. 4, 2025

(54) INFORMATION PROCESSING SYSTEM, NON-TRANSITORY COMPUTER READABLE MEDIUM, AND INFORMATION PROCESSING METHOD

(71) Applicant: FUJIFILM Business Innovation Corp., Tokyo (JP)

(72) Inventors: Masahiko HARADA, Kanagawa (JP); Sho Nagase, Kanagawa (JP); Atsushi Mori, Kanagawa (JP)

(73) Assignee: FUJIFILM Business Innovation Corp., Tokyo (JP)

(21) Appl. No.: 18/767,334

(22) Filed: Jul. 9, 2024

(30) Foreign Application Priority Data
Mar. 4, 2024 (JP) 2024-031862

(51) Int. Cl. G06F 9/48; G06F 9/30

(52) U.S. Cl. CPC G06F 9/4893; G06F 9/3009

(57) ABSTRACT

An information processing system includes a multiprocessor including: a main processor configured to control execution of a piece of software including a plurality of threads; and one or more sub-processors, the main processor being configured to: schedule, under a normal operation mode, each of the plurality of threads included in the piece of software to one of the processors forming the multiprocessor for execution; and perform, in response to a transition instruction from the normal operation mode to a power saving mode, control of performing a setting of preventing each of the threads from being scheduled to each of the one or more sub-processors, and then of stopping energization to the each of the one or more sub-processors.

### CROSS-REFERENCE TO RELATED APPLICATIONS

This application is based on and claims priority under 35 USC 119 from Japanese Patent Application No. 2024-031862 filed Mar. 4, 2024.

### BACKGROUND

### (i) Technical Field

The present disclosure relates to an information processing system, a non-transitory computer readable medium, and an information processing method.

### (ii) Related Art

Conventionally, when one computer program is to be executed, multi-thread processing has been performed, where the program is divided into a plurality of threads and processed in parallel. In order to cause threads to be processed simultaneously and in parallel, processing is performed by a computer equipped with a plurality of central processing units (CPUs), that is, a so-called multi-CPU computer, thereby making it possible to dramatically increase a processing speed for a program.

In addition, a multifunction machine in many cases has a function of automatically transitioning to a power saving state called a power saving mode or a sleep mode in order to reduce consumption of electric power when a non-operating state continues for a predetermined period of time while in a state where normal operation is possible. When a multi-CPU is mounted on a multifunction machine and a piece of software having a multi-thread configuration (a “program” described above) is to be executed, a main CPU included in the multi-CPU transitions to a power saving state in cooperation with other sub-CPUs.

Example of the related art are disclosed in Japanese Unexamined Patent Application Publication Nos. 2017-156907 and 2008-257578.

### SUMMARY

some threads may utilize results of processing on other threads. That is, when a plurality of processors process some of threads included in one piece of software simultaneously and in parallel, it is necessary to take into consideration an order of processing on the some of the threads. Therefore, the plurality of processors are required to perform control at a software level, such as determination and adjustment, as to whether or not a thread is in a state of being able to transition to a power saving mode in response to a transition instruction to the power saving mode.

In addition, the plurality of processors may not be always allowed to independently transition to the power saving mode in response to a transition instruction to the power saving mode, but it is necessary to take into consideration, for example, execution states of threads in other processors. Therefore, a main processor that operates in an initiative manner among the plurality of processors is required to perform control at a hardware level, such as determination and adjustment, as to whether or not to allow another sub-processor to transition to the power saving mode.

That is, when a piece of software is executed by scheduling, under a multiprocessor environment including a main processor and a sub-processor, each of a plurality of threads forming the piece of software to the main processor or the sub-processor, the main processor is required to perform control on both the threads and the sub-processor in order to improve a power saving effect.

Aspects of non-limiting embodiments of the present disclosure relate to improvement of a power saving effect when a piece of software is executed by scheduling, under a multiprocessor environment including a main processor and a sub-processor, each of a plurality of threads forming the piece of software to the main processor or the sub-processor, compared with a case where energization control for a sub-processor is not performed.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a multiprocessor including: a main processor configured to control execution of a piece of software including a plurality of threads; and one or more sub-processors, the main processor being configured to schedule, under a normal operation mode, each of the plurality of threads included in the piece of software to one of the processors forming the multiprocessor for execution, and perform, in response to a transition instruction from the normal operation mode to a power saving mode, control of performing a setting of preventing each of the threads from being scheduled to each of the one or more sub-processors, and then of stopping energization to the each of the one or more sub-processors.

### BRIEF DESCRIPTION OF THE DRAWINGS

An exemplary embodiment of the present disclosure will be described in detail based on the following figures, wherein:

FIG. 1 is a schematic block configuration diagram illustrating a hardware configuration of an image forming apparatus according to the present exemplary embodiment;

FIG. 2 is a block configuration diagram illustrating a controller according to the present exemplary embodiment;

FIG. 3 is a diagram illustrating an example of a data configuration of a thread management table 34 according to the present exemplary embodiment;

FIG. 4 is a diagram illustrating an example of a data structure of an attribute information management region according to the present exemplary embodiment;

FIG. 5 is a diagram schematically illustrating a configuration of a run queue according to the present exemplary embodiment;

FIG. 6A is a flowchart illustrating operation mode switching processing performed in the image forming apparatus according to the present exemplary embodiment;

FIG. 6B is a flowchart subsequent to FIG. 6A; and

FIG. 7 is a diagram illustrating an example of changing a data setting in the attribute information management region when transitioning to a power saving mode, according to the present exemplary embodiment.

### DETAILED DESCRIPTION

A preferred exemplary embodiment of the present disclosure will now be described herein with reference to the accompanying drawings.

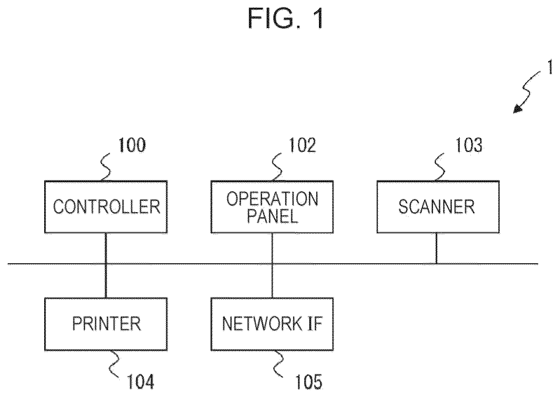

FIG. 1 is a schematic block configuration diagram illustrating a hardware configuration of an image forming apparatus 1 according to the present exemplary embodiment. The image forming apparatus 1 is a multifunction machine having various types of functions such as a printing function, a copying function, and a scanner function, and is an apparatus including a computer. The image forming apparatus 1 includes a controller 100, an operation panel 102, a scanner 103, a printer 104, and a network interface (IF) 105. The controller 100 is a control board corresponding to the computer described above. The computer according to the present exemplary embodiment is a computer including a multi-CPU including a main CPU serving as a main processor and one or more sub-CPUs serving as sub-processors.

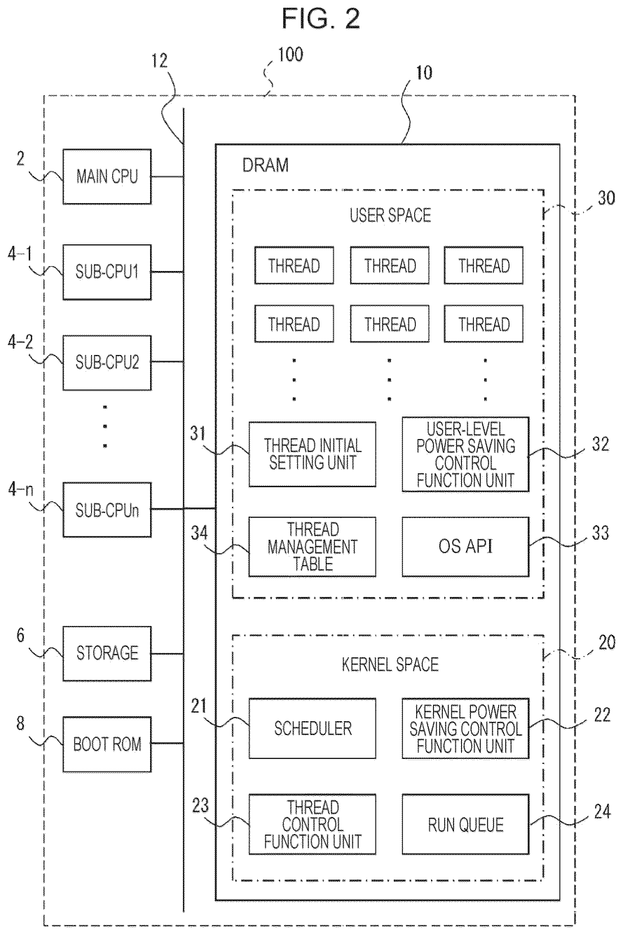

FIG. 2 is a block configuration diagram illustrating the controller 100 according to the present exemplary embodiment. The controller 100 according to the present exemplary embodiment is a control board mounted with a main CPU 2, a plurality of sub-CPUs 4-1 to 4-n, a storage 6, a boot read-only memory (ROM) 8, and a dynamic random access memory (DRAM) 10, which are coupled to each other via a control line 12. Note that components that are not used to describe the present exemplary embodiment are omitted from the drawings. Furthermore, the sub-CPUs 4-1 to 4-n are collectively referred to as the “sub-CPUs 4” when it is not necessary to distinguish the sub-CPUs from each other. There may be one or more sub-CPUs 4 in order to construct a multi-CPU environment.

The image forming apparatus 1 according to the present exemplary embodiment is able to execute a piece of priority-based multi-thread configuration software. The term “multi-thread configuration software” refers to a piece of software configured by dividing a single piece of software, that is, for example, a software program such as an application, into a plurality of threads. The term “priority-based” means that a degree of priority is set for each of a plurality of threads, and the threads are each processed in order in accordance with the set degree of priority.

The main CPU 2 and the sub-CPUs 4 are equivalent to each other in that all execute threads, and, furthermore, each perform operation control for various types of mechanisms mounted on the image forming apparatus 1, such as the scanner 103 and the printer 104, in accordance with an operating system (hereinafter referred to as the “OS”) and an application loaded in the DRAM 10. Among them, the main CPU 2 controls execution of the multi-thread configuration software described above. In other words, among the plurality of CPUs 2, 4, the CPU that controls execution of the multi-thread configuration software is regarded as the main CPU 2, and the other CPUs are regarded as the sub-CPUs 4. Note that the main CPU 2 is a sole CPU that first starts to operate when the image forming apparatus 1 is started, and executes a boot loader accordingly.

The storage 6 is a storage unit that stores pieces of software such as the OS and applications. The boot ROM 8 is a storage unit that stores a computer program that is to be automatically executed immediately after the computer is started. This computer program is commonly referred to as a “boot loader”.

The dynamic RAM (DRAM) 10 is a volatile semiconductor storage device loaded with the OS, the applications, and, in particular, threads forming a program. The DRAM 10 is partitioned, for use, into a storage region (hereinafter referred to as a “kernel space”) 20 into which a kernel (hereinafter also referred to as an “OS kernel”) serving as a core of the OS is loaded and a storage region (hereinafter referred to as a “user space”) 30 into which a piece of software other than the kernel is loaded. A method of utilizing the DRAM 10 may be similar or identical to those applied conventionally.

The DRAM 10 according to the present exemplary embodiment is able to operate under a self-refresh mode. The term “self-refresh mode” refers to a style for automatically generating a refresh instruction signal inside the DRAM 10 in a state where the DRAM 10 is not operating to execute refresh operation. The term “refresh” refers to operation for periodically supplying electric charge to a memory cell to periodically rewrite a piece of data during operation. By performing refreshing, the piece of data on the DRAM 10 is not erased, but is saved, and, furthermore, it is possible to expect a power saving effect. The DRAM 10 according to the present exemplary embodiment, to which no electric power is supplied when its mode has been transitioned to a power saving mode, is subject to control of refresh operation under the power saving mode.

By the way, the “power saving mode” refers to an operation mode that is different from a normal mode representing a normal state allowing a device such as the scanner 103 mounted on the image forming apparatus 1 to operate, and refers to an operation mode under which the image forming apparatus 1 enters a power saving state as supply of electric power to the device such as the scanner 103 is stopped. Under the power saving mode according to the present exemplary embodiment, energization to the DRAM 10 is stopped. When a state where the image forming apparatus 1 does not operate for a predetermined period of time continues, the operation mode in the image forming apparatus 1 automatically transitions from the normal mode to the power saving mode. Thereby, although the functions such as the scanner function that the image forming apparatus 1 provides are restricted in operation, consumption of electric power is reduced.

In a case of the present exemplary embodiment, the user space 30 includes a thread initial setting unit 31, a user-level power saving control function unit 32, an OS application programming interface (API) 33, and a thread management table 34.

The thread initial setting unit 31 performs an initial setting for each thread to be generated. Content of the initial setting is registered in the thread management table 34. The user-level power saving control function unit 32 has a function of performing control such as providing a request to the OS kernel and performing a setting when transitioning to the power saving mode. The OS API 33 is an API utilized when the OS kernel is called from the user space 30 to exchange a piece of information.

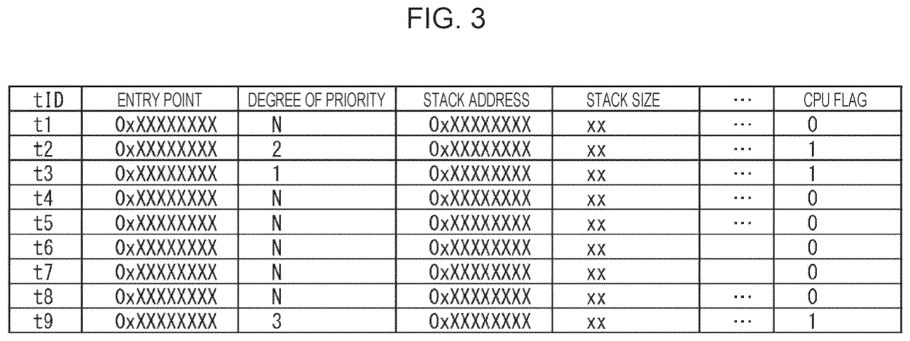

FIG. 3 is a diagram illustrating an example of a data configuration of the thread management table 34 according to the present exemplary embodiment. The thread management table 34 holds, in a table form, a piece of operation attribute information for managing, for a thread, content of an attribute setting for the thread. As illustrated in FIG. 3, a record that is set for a thread is formed by associating a piece of identification information (tID) of the thread with items of an entry point, a degree of priority, a stack address, a stack size, and a CPU flag. The items forming a record may be similar or identical to those applied conventionally. The degree of priority and the CPU flag used in the present exemplary embodiment, among them, will now be described herein. The degree of priority represents priority information related to an order of executing a thread, meaning that the higher the degree of priority, the more preferentially the execution of the thread. The CPU flag is set with either a flag value of “1” as first information indicating that scheduling is possible only to the main CPU 2 or a flag value of “0” as second information indicating that scheduling is possible to one of the CPUs 2, 4. The CPU flag is set with, for example, one of the flag values by a user such as an owner of a piece of software forming threads.

The components 31 to 33 in the user space 30 are achieved through cooperative operation of the main CPU 2 or the sub-CPUs 4 and a program running on the CPUs 2, 4. Furthermore, the thread management table 34 is stored in the storage 6, and is used when loaded into the user space 30 in the DRAM 10.

On the other hand, the kernel space 20 according to the present exemplary embodiment includes a scheduler 21, a kernel power saving control function unit 22, a thread control function unit 23, and a run queue 24.

The scheduler 21 performs scheduling of a thread, such as allocation of the thread to one of the CPUs 2, 4. The kernel power saving control function unit 22 has a function of controlling, when transitioning to the power saving mode, transition to the power saving mode in cooperation with the user-level power saving control function unit 32. The thread control function unit 23 controls execution of a thread coupled to the run queue 24. In the run queue 24, threads that are executable and that wait for processing by the CPUs 2, 4 are queued.

The components 21 to 23 in the kernel space 20 are achieved through cooperative operation of the main CPU 2 or the sub-CPUs 4 and a program running on the CPUs 2, 4. Furthermore, the run queue 24 is stored in the storage 6, and is used when loaded into the kernel space 20 in the DRAM 10.

The components 21 to 23 and 31 to 33 described above may be of course pre-installed in the image forming apparatus 1, or may be provided via a communication unit, or may be stored in a computer readable recording medium such as a universal serial bus (USB) memory for provision.

Next, operation in the present exemplary embodiment will now be described herein.

The CPUs 2, 4 according to the present exemplary embodiment each execute, among a plurality of threads (hereinafter also referred to as “multi-threads”) forming a piece of multi-thread configuration software, one of the threads, which is assigned by the scheduler 21. Initialization processing for the multi-threads, which is necessary for the scheduler 21 to execute scheduling will now be described herein.

As described above, the thread initial setting unit 31 performs an initial setting for a piece of attribute information related to each of the threads to be generated, and sets, registers, and manages the piece of attribute information in the thread management table 34 illustrated in FIG. 3. The degree of priority and the CPU flag to be set in the thread management table 34 are set for each of the threads by a user referring to content of the piece of software.

The thread initial setting unit 31 calls the OS API 33 for thread initialization and passes the piece of operation attribute information of each of the threads, which is set in the thread management table 34, to the thread control function unit 23.

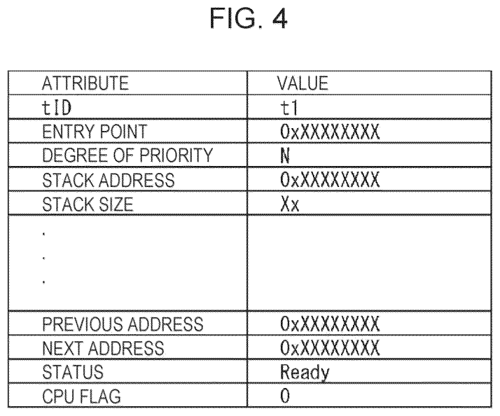

The thread control function unit 23 copies and stores the received piece of operation attribute information for each of the threads in an internal attribute information management region. FIG. 4 illustrates an example of a data structure of an attribute information management region that is set for each of threads to allow the thread control function unit 23 to manage a piece of operation attribute information for each of the threads. As is obvious from a comparison between FIGS. 3 and 4, basically identical pieces of information are managed, although data structures for managing the pieces of operation attribute information are different from each other.

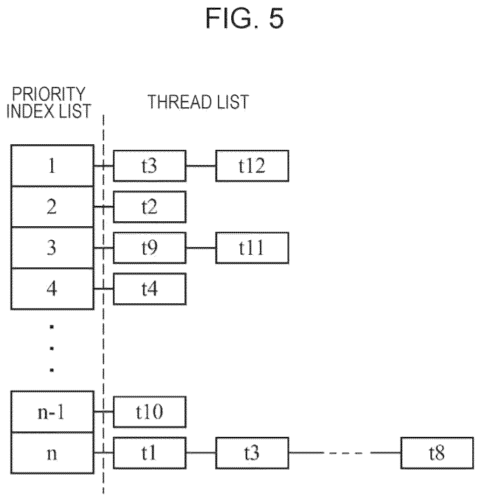

FIG. 5 is a diagram schematically illustrating a configuration of the run queue 24 used when scheduling is performed. In FIG. 5, the degrees of priority are listed in a priority index list in an order of degrees of priority 1 to n. A thread is queued in association with each of the degrees of priority included in the priority index list.

When a thread is in an executable state, the thread control function unit 23 refers to the degree of priority that is set in the attribute information management region corresponding to the thread, and registers the thread in the priority index list that corresponds to the corresponding degree of priority. When the degree of priority that is subject to registration has already been registered with another thread, the thread control function unit 23 queues continuously the thread at an end of the another thread. Note that a method of queuing, which is performed by the thread control function unit 23, may be similar or identical to those applied conventionally.

After multi-threads are initialized as described above, scheduling is performed in the scheduler 21.

That is, when started, the scheduler 21 selects a thread having a higher degree of priority from the thread list registered in the run queue 24, and allocates a resource such as the CPU 2 or 4 to the selected thread for execution. When performing scheduling, the scheduler 21 schedules the selected thread to the main CPU 2 or one of the sub-CPUs 4 in accordance with the CPU flag of the selected the thread, which is set in the operation attribute information. Specifically, when the CPU flag of the selected thread is “1”, the scheduler 21 allocates the main CPU 2 to the selected thread. When the CPU flag of the selected thread is “0”, the scheduler 21 allocates the selected thread to either the CPU 2 or 4 in accordance with a predetermined rule. The predetermined rule is, for example, a CPU waiting for processing or a CPU with a minimum load. The predetermined rule itself may be similar or identical to those applied conventionally.

When the image forming apparatus 1 is started and is operating under the normal mode, a thread is registered in the run queue 24 when it is in an executable state under execution control by the OS kernel, and is scheduled for execution. As the thread is executed, the scanner 103 or the printer 104 operates.

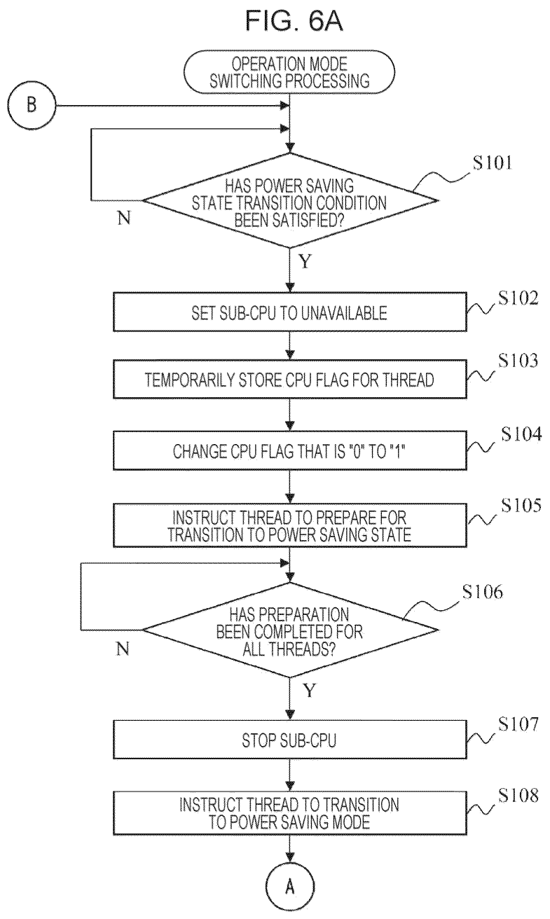

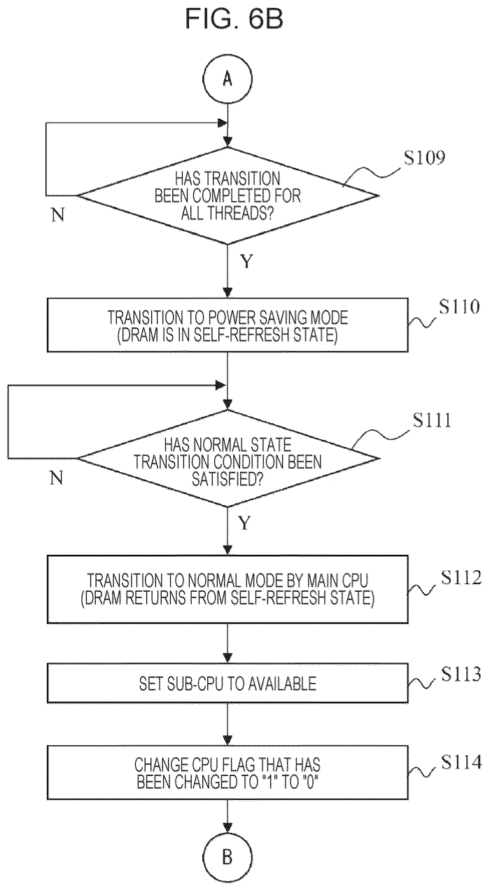

Subsequently, operation mode switching processing that is to be executed when the operation mode of the image forming apparatus 1 is transitioned from the normal mode to the power saving mode or from the power saving mode to the normal mode will now be described herein with reference to the flowcharts illustrated in FIGS. 6A and 6B.

While a predetermined condition for transitioning to the power saving mode is not satisfied, such as there is no external input via the network for a certain period of time, in a state of operation under the normal mode (N in step S101), the image forming apparatus 1 continuously operates under the normal mode. As the predetermined condition for transitioning to the power saving mode is satisfied (Y in step S101), preparation for transitioning to the power saving mode starts.

Upon detection of a state where transitioning to the power saving mode is ready, the user-level power saving control function unit 32 first calls the OS API (system call) 33, thereby starting preparation for transitioning to the power saving mode in cooperation with the OS kernel.

In response to the calling of the OS API 33, the kernel power saving control function unit 22 forming the OS kernel sets each of all the sub-CPUs 4 to an unavailable state by, for example, setting an unavailability flag that has been provided to be set for each of the sub-CPUs 4 (step S102). The unavailability flag is managed in the OS kernel.

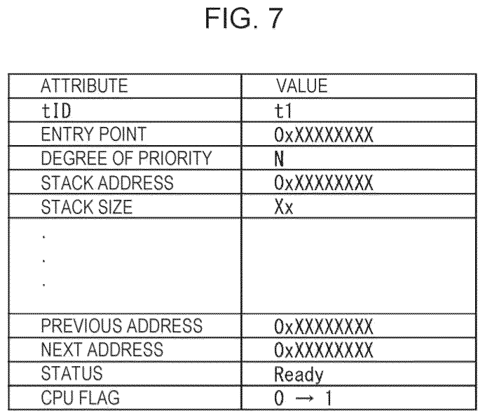

Furthermore, the thread control function unit 23 forming the OS kernel temporarily stores a current setting value of the CPU flag that is included in the attribute information management region corresponding to each of the threads (step S103), and then changes the CPU flag of each of all ones of the threads, which has the current setting value of “0”, to “1” (step S104). That is, the ones of threads are scheduled only to the main CPU 2, and are set to be executable only in the main CPU 2. FIG. 7 illustrates an example of a case of changing, in setting, the CPU flag in the attribute information management region when transitioning to the power saving mode. In the example illustrated in FIG. 7, the setting values after changed are each temporarily stored in a setting region for the CPU flag.

In the present exemplary embodiment, control is performed to prevent a thread from being scheduled to one of the sub-CPUs 4 as described above.

In response to the calling of the OS API (system call) 33 as described above, the user-level power saving control function unit 32 instructs a thread to prepare for transition to the power saving state (step S105). In response to this instruction, the thread transitions to a state capable of responding to transition to the power saving mode. The user-level power saving control function unit 32 waits until a power saving state transition possible status indicating that preparation for transition to the power saving state has been completed is returned from all of the threads (N in step S106). Then, when a response indicating that preparation for transition to the power saving state has been completed is sent back from all the threads (Y in step S106), the user-level power saving control function unit 32 issues a power saving transition instruction to the OS kernel. In response to the power saving transition instruction, the kernel power saving control function unit 22 performs control to stop energization to the sub-CPUs 4 for stopping operation (step S107).

Furthermore, the user-level power saving control function unit 32 issues a power saving mode transition instruction to each of the threads, which is operating in the main CPU 2 (step S108). By the way, since the CPU flag for each of all the threads is set with “1” at this point in time in step S104, all the threads that operate are subject to provision of the power saving mode transition instruction.

Although all the threads that operate are supposed to transition to the power saving mode in response to this instruction, the user-level power saving control function unit 32 waits until all the threads transition to the power saving mode (N in step S109). Then, as it is confirmed that all the threads have transitioned to the power saving mode (Y in step S109), the user-level power saving control function unit 32 notifies the OS kernel to that effect. In response to this notification, the kernel power saving control function unit 22 causes the image forming apparatus 1 to transition to the power saving mode (step S110).

As the image forming apparatus 1 transitions to the power saving mode, supply of electric power to devices such as the scanner 103 and the printer 104 is stopped. Furthermore, the DRAM 10 according to the present exemplary embodiment starts a self-refresh operation and enters a self-refresh state.

As described above, the image forming apparatus 1 operates under the power saving mode. Under the power saving mode, supply of electric power to the scanner 103, the sub-CPUs 4, the DRAM 10, and the like is stopped, and thus power saving is achieved.

After that, the image forming apparatus 1 continuously operates under the power saving mode while a predetermined condition for transitioning to the normal mode, such as the user operates the operation panel 102, is not satisfied (N in step S111). As the predetermined condition for transitioning to the normal mode is satisfied (Y in step S111), the OS kernel that is operating in the main CPU 2 causes the image forming apparatus 1 to transition to the normal mode (step S112). Specifically, supply of electric power to a device such as the scanner 103 or the printer 104 is started to attain an operable state. Furthermore, the OS kernel performs control to resume energization to the sub-CPUs 4. Thereby, the sub-CPUs 4 each return to the operable state. Furthermore, the DRAM 10 according to the present exemplary embodiment returns from the self-refresh state.

Furthermore, the kernel power saving control function unit 22 sets all the sub-CPUs 4 to be each in an available state by, for example, clearing the unavailability flag set for each of the sub-CPUs 4 (step S113). Thereby, all the subs CPU 4 return to a state where execution of a thread is possible.

Subsequently, as transition from the power saving mode to the normal mode is completed, the user-level power saving control function unit 32 calls the OS API (system call) 33.

The thread control function unit 23 forming the OS kernel changes and returns the CPU flag corresponding to each of ones of the threads, for which the setting of the CPU flag, which is included in the attribute information management region, has been changed from “0” to “1” when transitioning to the power saving mode, to “0” (step S114). Thereby, ones of the threads, which are each originally available for scheduling to one of the CPUs 2, 4, are each allocated with a desired resource, that is, the CPU 2 or 4, become an executable state.

According to the present exemplary embodiment, the operation mode is switched in the image forming apparatus 1 as described above.

When a thread that is subject to priority control, specifically, a thread for which an item of the degree of priority is set in the thread management table, is allowed to operate under a multi-CPU environment, adjustment is necessary between threads operating in a distributed manner among the plurality of CPUs 2 and 4, that is, adjustment is necessary at a software level, when transitioning to the power saving mode. Furthermore, adjustment of stop control and the like among the CPUs, that is, adjustment at a hardware level is also necessary. That is, in addition to necessity in adjustment in each of hardware and software, cooperation between both the hardware and the software is necessary, leading to complication.

When a piece of priority-based multi-thread configuration software is to be operated under a multi-CPU environment in the present exemplary embodiment as described above, all threads that are executable in the plurality of CPUs 2 and 4 are each changed to an executable state only in the main CPU 2, and the sub-CPUs 4 are controlled to be stopped, in other words, a multi-CPU system environment is changed to a single-CPU system environment, when transitioning to the power saving mode, thereby making it possible to achieve transition to the power saving mode without performing complicated adjustment between software and hardware.

By the way, although, since the main CPU 2 is a single CPU that first operates when a power source of the image forming apparatus 1 is turned on, and is a single CPU that executes the boot loader, the main CPU 2 is selected to represent the image forming apparatus 1 as a single CPU that is executable of all threads when transitioning to the power saving mode in the present exemplary embodiment, one of the sub-CPUs 4 may be selected.

The “information processing system” according to the present exemplary embodiment, which has been described as one including the single image forming apparatus 1 incorporating a computer as an example, may include an information processing apparatus such as a personal computer (PC) and a plurality of devices, for example.

In the exemplary embodiment described above, the processor refers to a processor in a broad sense, and includes general-purpose processors (for example, central processing units (CPUs)) and dedicated processors (for example, graphics processing units (GPUs), application specific integrated circuits (ASICs), field programmable gate arrays (FPGAs), and programmable logic devices).

Furthermore, operations of the multiprocessor in the exemplary embodiment described above may be operations performed, in cooperation with each other, by a plurality of processors that exist at physically separated positions. Furthermore, the order of the operations of the processor is not limited to the order described in the exemplary embodiment described above, and may be appropriately modified.

### APPENDIX

(((1)))

An information processing system comprising a multiprocessor including: a main processor configured to control execution of a piece of software including a plurality of threads; and one or more sub-processors, the main processor being configured to schedule, under a normal operation mode, each of the plurality of threads included in the piece of software to one of the processors forming the multiprocessor for execution, and perform, in response to a transition instruction from the normal operation mode to a power saving mode, control of performing a setting of preventing each of the threads from being scheduled to each of the one or more sub-processors, and then of stopping energization to the each of the one or more sub-processors.

(((2)))

The information processing system according to (((1))), wherein the main processor is configured to: schedule, under the normal operation mode, each of the plurality of threads to the main processor or each of the one or more sub-processors in accordance with a piece of operation attribute information that is set in advance for each of the plurality of threads, the operation attribute information being set with either first information indicating that scheduling is possible only to the main processor or second information indicating that scheduling is possible to one of the processors; and perform, in response to a transition instruction from the normal operation mode to the power saving mode, control of changing all settings in the pieces of operation attribute information, each of which has been set with the second information, to the first information, and then of stopping energization to the each of the one or more sub-processors.

(((3)))

The information processing system according to (((2))), wherein the main processor is configured to: perform control of resuming, in response to a return instruction from the power saving mode to the normal operation mode, energization to each of the one or more sub-processors; and to return, after energization to each of the one or more sub-processors is started, one or more of the pieces of operation attribute information for one or more of the threads, for which the settings of the one or more of the pieces of operation attribute information have been changed from the second information to the first information during transition to the power saving mode, to the second information.

(((4)))

A program causing a computer including a multiprocessor including a main processor configured to control execution of a piece of software including a plurality of threads and one or more sub-processors to execute a process comprising: causing the main processor to execute scheduling of, under a normal operation mode, each of the plurality of threads included in the piece of software to one of the processors forming the multiprocessor for execution; and causing the main processor to execute control of, in response to a transition instruction from the normal operation mode to a power saving mode, performing a setting of preventing each of the threads from being scheduled to each of the one or more sub-processors, and then stopping energization to the each of the one or more sub-processors.

(((5)))

An information processing method comprising causing a multiprocessor included in an information processing system, the multiprocessor including a main processor configured to control execution of a piece of software including a plurality of threads and one or more sub-processors, to schedule, under a normal operation mode, each of the plurality of threads included in the piece of software to one of the processors forming the multiprocessor for execution, and to perform, in response to a transition instruction from the normal operation mode to a power saving mode, control of performing a setting of preventing each of the threads from being scheduled to each of the one or more sub-processors, and then of stopping energization to the each of the one or more sub-processors.

What is claimed is:

1. An information processing system comprising:
a multiprocessor including:
a main processor configured to control execution of a piece of software including a plurality of threads; and
one or more sub-processors,
the main processor being configured to:
schedule, under a normal operation mode, each of the plurality of threads included in the piece of software to one of the processors forming the multiprocessor for execution; and
perform, in response to a transition instruction from the normal operation mode to a power saving mode, control of performing a setting of preventing each of the threads from being scheduled to each of the one or more sub-processors, and then of stopping energization to the each of the one or more sub-processors.

2. The information processing system according to claim 1, wherein the main processor is configured to:
schedule, under the normal operation mode, each of the plurality of threads to the main processor or each of the one or more sub-processors in accordance with a piece of operation attribute information that is set in advance for each of the plurality of threads, the operation attribute information being set with either first information indicating that scheduling is possible only to the main processor or second information indicating that scheduling is possible to one of the processors; and
perform, in response to a transition instruction from the normal operation mode to the power saving mode, control of changing all settings in the pieces of operation attribute information, each of which has been set with the second information, to the first information, and then of stopping energization to the each of the one or more sub-processors.

3. The information processing system according to claim 2, wherein the main processor is configured to:
perform control of resuming, in response to a return instruction from the power saving mode to the normal operation mode, energization to each of the one or more sub-processors; and
return, after energization to each of the one or more sub-processors is started, one or more of the pieces of operation attribute information for one or more of the threads, for which the settings of the one or more of the pieces of operation attribute information have been changed from the second information to the first information during transition to the power saving mode, to the second information.

4. A non-transitory computer readable medium storing a program causing a computer including a multiprocessor including a main processor configured to control execution of a piece of software including a plurality of threads and one or more sub-processors to execute a process comprising:
causing the main processor to execute scheduling of, under a normal operation mode, each of the plurality of threads included in the piece of software to one of the processors forming the multiprocessor for execution; and
causing the main processor to execute control of, in response to a transition instruction from the normal operation mode to a power saving mode, performing a setting of preventing each of the threads from being scheduled to each of the one or more sub-processors, and then stopping energization to the each of the one or more sub-processors.

5. An information processing method comprising:
causing a multiprocessor included in an information processing system, the multiprocessor including a main processor configured to control execution of a piece of software including a plurality of threads and one or more sub-processors,
to schedule, under a normal operation mode, each of the plurality of threads included in the piece of software to one of the processors forming the multiprocessor for execution, and to perform, in response to a transition instruction from the normal operation mode to a power saving mode, control of performing a setting of preventing each of the threads from being scheduled to each of the one or more sub-processors, and then of stopping energization to the each of the one or more sub-processors.
